(19) United States
(12) Patent Application Publication
(10) Pub. No.: US 2017/0315631 A1
(43) Pub. Date: Nov. 2, 2017

(54) SYSTEM AND METHOD FOR MULTIMODE STYLUS

(71) Applicant: QUALCOMM INCORPORATED, San Diego, CA (US)

(72) Inventors: Fariborz POURBIGHARAZ, San Diego (CA); Nathan ALTMAN, San Diego (CA)

(21) Appl. No.: 15/142,754

(22) Filed: Apr. 29, 2016

(51) Int. Cl. G06F 3/038; G06F 3/041; G06F 3/0354; G06F 3/044

(52) U.S. Cl. CPC G06F 3/0383; G06F 3/044; G06F 3/0414; G06F 3/03545; G06F 3/0418; G06F 2203/04106; G06F 2203/04108

(57) ABSTRACT

Detection of a position of a stylus includes a touch screen, a plurality of detectors, and a control unit. The control unit is configured to detect a position of a stylus using the touch screen in an active touch input mode wherein the touch screen detects first signals from the stylus, determine a signal to noise ratio (SNR) of the active touch input mode, switch to detection of the position of the stylus using the detectors in an active non-touch input mode wherein the detectors detect second signals from the stylus when the SNR of the active touch input mode is below first a threshold, determine a SNR of the active non-touch input mode, and switch back to detection of the position of the stylus using the active touch input mode when the SNR of the active non-touch input mode is lower than a second threshold.

### TECHNICAL FIELD

The present disclosure relates generally to input methods for computing devices, and more particularly to input using a multimode stylus.

### BACKGROUND

Many of today's computing devices such as mobile phones, tablets, laptops, PCs, and the like operate using graphical user interfaces that detect and react to input events where the location or position where the input event occurs is important in knowing the intent of the user. For example, when a click or tap event is detected, it is important to know which user interface element, such as a button, is being clicked or tapped on. This can be determined by tracking or locating the source of an input element such as a mouse, a trackball, a finger, a stylus, and/or the like at the time the event occurred. As another example, the detection of the gestures and/or stroke-type events is also important in the context of user interfaces providing support for dragging, drawing, handwriting, and/or similar functionality.

Many input technologies are available to support the location awareness associated with graphical user interfaces. More traditional input technologies for location awareness have included input devices, such as mice, trackballs, joy sticks, touch pads, and/or the like, whose position relative to a display screen is irrelevant, but whose relative motion is actively tracked and displayed to the user on the display screen using a cursor or pointer icon. However, with the advent of touch-sensitive displays and other position detection technology that locates an input device relative to the display screen, the tracking cursor is no longer as important because the position of the input device relative to the display screen indicates where the user is interacting with the graphical user interface. Some of the input technologies supporting this interaction approach include both touchscreens and non-touch input methods using trackable devices such as specialized styli. Examples of touch technologies include resistive, surface acoustic wave, capacitive, projected capacitive, infrared grid, optical, dispersive signal, and acoustic pulse. Examples of non-touch input technologies include acoustic, ultrasonic, radio frequency (RF), electromagnetic resonant, and vision.

No one touch or non-touch technology is ideal in all situations as each has its own advantages and disadvantages. For example, resistive touch technologies do not require the use of a special stylus as they may be used with anything that can apply pressure to a touch screen, such as a finger, a gloved finger, and/or the like. Resistive touch technologies use typically low power, but involve the application of pressure to the touch screen which makes them susceptible to damage from the pressing object and not able to detect inputs that are not in contact with touch screen. Resistive technologies also typically reduce the contrast of the touch screen as the electrodes and conductive elements used to implement the touch screen interfere with the display functions of the touch screen.

Capacitive technologies detect changes in capacitance in an array of electrodes and conductors in the touch screen and thus support both passive input devices (e.g., a conductive stylus or an ungloved finger) and active styli that emanate one or more electric fields at their tip as well as the ability to detect inputs hovering near the surface of the touch screen. Passive and active capacitive modes typically involve a trade-off between the greater detectability of active modes over the passive modes with the increased cost and higher power consumption associated with active styli. Active modes further provide the ability for the active styli to transfer data to the touch screen by modulating the one or more electric fields being emanated. Capacitive modes, however, are subject to interference from high humidity, fluorescent light, noise from battery charging circuitry in the touch screen, accidental detection of hands and palms, etc.

Non-touch technologies, such as ultrasonic positioning, use two or more detectors, such as microphones, to detect signals emitted by an active stylus and triangulate the position of the active stylus. Thus, non-touch technologies may detect the active stylus even when the active stylus is not in contact with a display surface and/or located to the side of the display surface. As an active technology, non-touch technologies may also transfer data to the host operating the display. Non-touch technologies, however, are often sensitive to temperature, obstruction of one or more of the detectors, environmental noise detectable by the sensors, etc. and typically consume more power than touch technologies such as capacitive technologies.

Accordingly, it would be desirable to provide systems and methods that can interface with a multimode stylus and are able to switch between two or more input technologies to take advantage of the input technology that is better suited for the current input conditions.

### SUMMARY

According to some embodiments a system includes a touch screen, a plurality of detectors, and a control unit. The control unit is configured to detect a position of a stylus using the touch screen in an active touch input mode wherein the touch screen detects one or more first signals emitted by the stylus, determine a signal to noise ratio of the active touch input mode, switch to detection of the position of the stylus using the plurality of detectors in an active non-touch input mode wherein the plurality of detectors detect one or more second signals emitted by the stylus when the signal to noise ratio of the active touch input mode is lower than a first threshold, determine a signal to noise ratio of the active non-touch input mode, and switch back to detection of the position of the stylus using the touch screen in the active touch input mode when the signal to noise ratio of the active non-touch input mode is lower than a second threshold.

According to some embodiments, a method performed by a host computing device includes detecting a position of a stylus using a touch screen in an active touch input mode, determining a signal to noise ratio of the active touch input mode, switching to detecting the position of the stylus using a plurality of detectors in an active non-touch input mode when the signal to noise ratio of the active touch input mode is lower than a first threshold, determining a signal to noise ratio of the active non-touch input mode, and switching back to detecting the position of the stylus using the touch screen in the active touch input mode when the signal to noise ratio of the active non-touch input mode is lower than a second threshold Detecting the stylus using the touch screen in the active touch input mode includes detecting, by the touch screen, one or more first signals emitted by the stylus. Detecting the stylus using the plurality of detectors in the active non-touch input mode includes detecting, by the plurality of detectors, one or more second signals emitted by the stylus.

According to some embodiments, a non-transitory computer-readable medium includes a plurality of computer-readable instructions which when executed by one or more processors associated with a host computing device are adapted to cause the one or more processors to perform a method. The method includes detecting a position of a stylus using a touch screen in an active touch input mode, determining a signal to noise ratio of the active touch input mode, switching to detecting the position of the stylus using a plurality of detectors in an active non-touch input mode when the signal to noise ratio of the active touch input mode is lower than a first threshold, determining a signal to noise ratio of the active non-touch input mode, and switching back to detecting the position of the stylus using the touch screen in the active touch input mode when the signal to noise ratio of the active non-touch input mode is lower than a second threshold. Detecting the stylus using the touch screen in the active touch input mode includes detecting, by the touch screen, one or more first signals emitted by the stylus. Detecting the stylus using the plurality of detectors in the active non-touch input mode includes detecting, by the plurality of detectors, one or more second signals emitted by the stylus.

### BRIEF DESCRIPTION OF THE DRAWINGS

FIG. 1 is a simplified diagram of a multimode stylus according to some embodiments.

FIG. 2 is a simplified diagram of a host computing device according to some embodiments.

FIG. 3 is a simplified schematic diagram of the multimode stylus of FIG. 1 according to some embodiments.

FIG. 4 is a simplified schematic diagram of the host computing device of FIG. 2 according to some embodiments.

FIG. 5 is a simplified diagram of a method of operating a multimode stylus according to some embodiments.

FIG. 6 is a simplified diagram of a method of selecting an input mode for a multimode stylus according to some embodiments.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

A computing device supporting multiple modes of input provides several advantages over single-mode approaches as the ability to switch between modes to adapt to changes in environmental, sensing, and/or other conditions allows the computing device to use the mode of input that is the most accurate and/or makes the most sense for the current conditions. For example, a multimode stylus for use as an input device to a host computing device may switch between passive and active modes and touch and non-touch modes based on current battery charge levels, noise levels, signal to noise ratios, interference sources, multimode stylus location, user preferences, and/or the like.

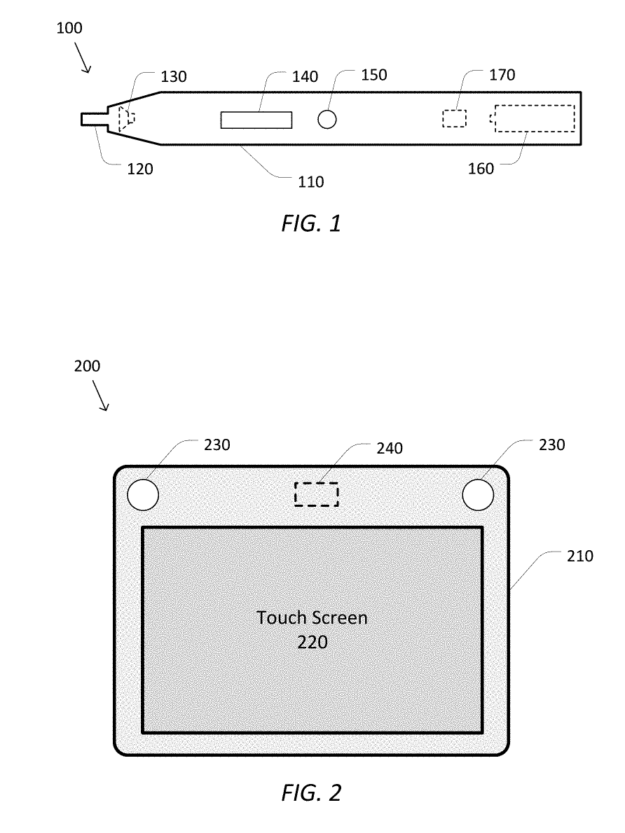

FIG. 1 is a simplified diagram of a multimode stylus 100 according to some embodiments. As shown in FIG. 1, multimode stylus 100 includes a housing 110 with a tip 120 located at one end of housing 110. Tip 120 serves as a pointing mechanism for multimode stylus 100 that a user may use to interact with a user interface implemented on a host computing device. In some examples, tip 120 is optionally composed of a flexible material so that as tip 120 is used with a touch screen, tip 120 is less likely to scratch or otherwise damage the touch screen. In some examples, tip 120 is optionally composed of a conductive material so that tip 120 is detectable by a touch screen using capacitive sensing technologies. In some examples, tip 120 may optionally include additional circuitry and/or elements, such as one or more switches, one or more pressure sensors, one or more surface conductive sensors, and/or the like, to detect when tip 120 is in contact with a surface, an amount of pressure applied by tip 120 on the surface, and/or the like.

Multimode stylus 100 further includes one or more emitters 130 to support the various input modes of multimode stylus 100. In some examples, the one or more emitters 130 may optionally include an emitter 130 for generating an electric field that can interact with the sensors of a touch screen using capacitive technologies. In some examples, the one or more emitters 130 may include an acoustic, ultrasonic, radio frequency, RF, infrared, light, and/or an electromagnetic emitter 130 that can emit signals by which detectors in a host computing device are able to triangulate a position of multimode stylus 100 and/or tip 110. In some examples, each of the one or more emitters 130 may emit continuous carrier signals, pulse signals, and/or any combination thereof. In some examples, the one or more emitters 130 may optionally include a combination of sound (acoustic and ultrasonic) and electromagnetic (RF, infrared, light) emitters 130 so that relative distance between the one or more emitters 130 and corresponding detectors in the host computing device may be determined based on differences between travel times in the electromagnetic and the sound signals. In some examples, each of the one or more emitters 130 may omit a signal that identifies multimode stylus 100.

Multimode stylus 100 further includes a status display 140 and a mode selection input 150 to support changing the input mode of multimode stylus 100 and communicating the input mode to a user. In some examples, status display 140 may optionally include one or more indicators, such as LEDs, that communicate the input mode using indicator patterns, colors, flashing patterns, backlit icons, backlit textual indicators, and/or the like. In some examples, status display 140 may optionally include a small text or other graphic display that communicate the input mode using text and/or icons, and/or support a menu and/or icon driven user interface that support user selection of the input mode. In some examples, status display 140 may optionally be used to display additional status information of multimode stylus 100. In some examples, mode selection input 150 may optionally include one or more buttons and/or touch-sensitive pads that can be used to toggle between input modes of multimode stylus 100, navigate the menu and/or icon driven user interface displayed on status display 140, and/or the like. In some examples, mode selection input 150 may optionally include a rotary or slide switch allowing a user to switch between the input modes.

Multimode stylus 100 further includes a power source, such as one or more batteries 160, which is used to provide power to multimode stylus 100. In some examples, the one or more batteries 160 are rechargeable by connecting a connector (not shown) on multimode stylus 100 to a power cable, such as a USB cable, or to a charging station. In some examples, the one or more batteries 160 are rechargeable using inductive power transfer. In some examples, the one or more batteries may comprise one or more capacitive power storage modules.

Multimode stylus 100 further includes a transceiver 170 used by multimode stylus 100 to send and receive information to a host computing device for which multimode stylus 100 is being used as an input device. Transceiver 170 typically supports wireless or RF communication with the host computing device so that multimode stylus 100 and the host computing device may exchange identifiers for multimode stylus 100 and/or host computing device, status information associated with multimode stylus 100 and/or host computing device, commands from the host computing device to multimode stylus 100, and/or the like. The status information associated with multimode stylus 100 may optionally include one or more of a charge level of the one or more batteries 160, pressure applied by tip 120 to a surface, an attitude of multimode stylus 100, the input mode of multimode stylus 100, grip pressure by a user on housing 110, detection of a grip by the user on housing 110, and/or the like. In some examples, the wireless or RF communication may optionally include communication using Bluetooth, Bluetooth Low Energy (BLE), near field communication (NFC), and/or similar technologies. In some examples, transceiver 170 may optionally support pairing between multimode stylus 100 and the host computing device before multimode stylus 100 is used as an input device for the host computing device.

According to some embodiments, multimode stylus 100 may optionally transmit information to the host computing device using the one or more emitters 130. In some examples, each of the one or more emitters 130 is coupled to a driver circuit that may optionally be used to modulate the information onto the emitted signals so that the information can be communicated to the host computing device. In some examples, the information may optionally include the identifier for multimode stylus 100 and/or the status information associated with multimode stylus 100. In some examples, the one or more emitters 130 may optionally replace and/or supplement the communication with the host computing device performed by transceiver 170.

According to some embodiments, multimode stylus 100 may optionally exchange heartbeat messages with the host computing device using transceiver 170. In some examples, when multimode stylus 100 and the host computing device are not able to exchange heartbeat messages this may indicate that multimode stylus 100 is no longer useful as an input device for the host computing device. In some examples, when multimode stylus 100 and the host computing device are not able to exchange heartbeat messages, multimode stylus may optionally switch to the passive input mode.

FIG. 2 is a simplified diagram of a host computing device 200 according to some embodiments. As shown in FIG. 2, host computing device 200 includes a housing 210 that is used to support a touch screen 220 and a plurality of detectors 230. According to some embodiments, host computing device 200 is consistent with a smart phone, a tablet, a laptop, a personal computer, and/or the like. In some embodiments, host computing device 200 is configured to use multimode stylus 100 as an input device using two or more input modes of multimode stylus 100. In a touch input mode, touch screen 220 is configured to detect when a tip of a stylus, such as tip 120, is in contact with and/or hovering just above touch screen 220 (e.g., within 5-20 mm or so of the surface of the touch screen) and the position of the tip on touch screen 220 based on interaction between the tip and touch screen 220 and/or based on interaction between one or more emitters of the stylus, such as the one or more emitters 130, and touch screen 220. In some examples, touch screen 220 may optionally operate using resistive, surface acoustic wave, capacitive, projected capacitive, infrared grid, optical, dispersive signal, acoustic pulse, force sensing, and/or other approaches. Depending upon the touch technology used by touch screen 220, touch screen 220 may optionally include one or more screen layers including patterns of conductors, and/or electrodes and/or one or more arrays of emitters and/or sensors located around the periphery of touch screen 220. In a non-touch input mode, the plurality of detectors 230 detect one or more signals emitted by one or more emitters of the stylus, such as the one or more emitters 130 and, based on differences between the detected signals, determine a position of the stylus relative to host computing device 200 and/or touch screen 220. In some examples, host computing device 200 is able to determine the position of the stylus even when the stylus is not in contact with touch screen 220 such as when the stylus is located above or below touch screen 220, located to one side or another of touch screen 220, and/or any combination thereof. Depending upon the non-touch technology used by the plurality of detectors 230 and/or host computing device 200, the plurality of detectors 230 may optionally detect acoustic, ultrasonic, RF, electromagnetic resonant, infrared, light, and/or other signals. In some examples, the plurality of detectors 230 may optionally include a combination of sound (acoustic and ultrasonic) and electromagnetic (RF, infrared, light) detectors 230 where relative distance between each of the plurality of detectors 230 and the stylus may be determined based on differences between signal power and/or travel times in the electromagnetic and the sound signals.

Host computing device 200 further includes a transceiver 240 used by host computing device 200 to communicate with the multimode stylus. Transceiver 240 typically supports wireless or RF communication with the multimode stylus so that host computing device 200 may exchange identifiers for host computing device 200 and/or the multimode stylus, status information associated with host computing device 200 and/or the multimode stylus, commands for the multimode stylus from host computing device 200, and/or the like. The status information associated with the multimode stylus may optionally include one or more of a charge level of the one or more batteries in the multimode stylus, pressure applied by a tip of the multimode stylus to a surface, an attitude of the multimode stylus, the input mode being used by the multimode stylus, grip pressure by a user on the multimode stylus, detection of a grip by a user on the housing of the multimode stylus, and/or the like. In some examples, the wireless or RF communication may optionally include communication using Bluetooth, BLE, NFC, and/or similar technologies. In some examples, transceiver 240 may optionally support pairing between host computing device 200 and the multimode stylus before the multimode stylus is used as an input device for host computing device 200.

According to some embodiments, host computing device 200 may optionally exchange heartbeat messages with the multimode stylus using transceiver 240. In some examples, when host computing device 200 and the multimode stylus are not able to exchange heartbeat messages this may indicate that the multimode stylus is no longer useful as an input device for the host computing system. In some examples, when host computing device 200 and the multimode stylus are not able to exchange heartbeat messages, host computing device 200 may optionally switch to the passive input mode.

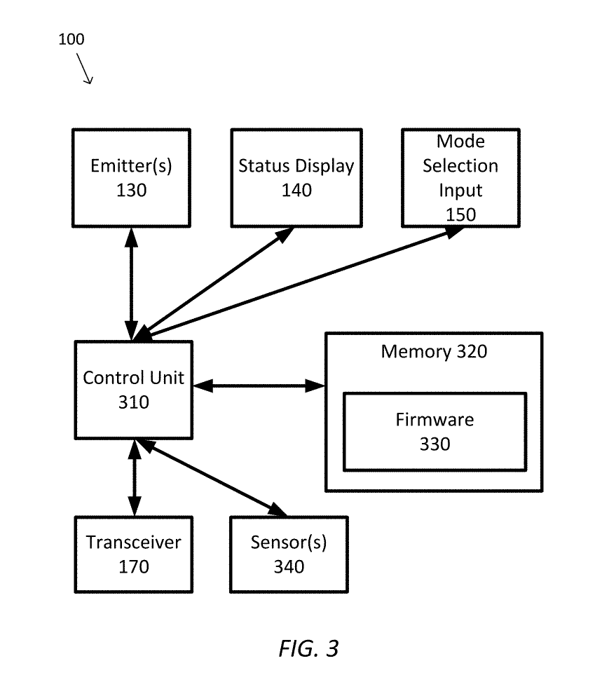

FIG. 3 is a simplified schematic diagram of multimode stylus 100 according to some embodiments. As shown in FIG. 3, multimode stylus 100 includes a control unit 310 coupled to memory 320. Operation of multimode stylus 100 is controlled by control unit 310. Control unit 310 may include one or more central processing units, multi-core processors, microprocessors, microcontrollers, digital signal processors, field programmable gate arrays (FPGAs), application specific integrated circuits (ASICs), and/or the like.

Memory 320 may be used to store software executed by control unit 310 and/or one or more data structures used during operation of multimode stylus 100. Memory 320 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

As shown, memory 320 includes firmware 330 that may be used to support use of multimode stylus 100 as an input device for a host computing device, such as host computing device 200. Firmware 330 may include one or more modules for operating the various components in multimode stylus 100 so that multimode stylus 100 may be operated in one or more input modes as is described in further detail below. In some examples, firmware 330 may include one or more application programming interfaces (APIs) for supporting interoperability among the various components in multimode stylus and/or the communication of information between multimode stylus 100 and the host computing device. And although firmware 330 is depicted as a software application, firmware 330 may be implemented using hardware, software, and/or a combination of hardware and software.

As shown, control unit 310 is coupled to the one or more emitters 130 so that control unit 310 and/or firmware 330 may control operation of the signals emitted by the one or more emitters 130. Each of the one or more emitters 130 is controlled and/or activated separately so that multimode stylus 100, through control unit 310 and/or firmware 330, can operate each of the one or more emitters 130 depending on the input mode of multimode stylus 100 is being operated in. In some examples, each of the one or more emitters 130 is deactivated and does not emit signals when multimode stylus 100 is operated in a passive input mode, such as when multimode stylus 100 is used in a mode consistent with a resistive, passive capacitive, surface acoustic wave, infrared grid, or similar technology. In some examples, one or more emitters 130 for generating an electric field is activated when multimode stylus 100 is used in an active capacitive input mode. In some examples, one or more emitters 130 for generating ultrasonic signals is activated when multimode stylus 100 is used in an ultrasonic non-touch input mode.

In some embodiments, when multimode stylus 100 includes two or more emitters 130, different combinations of the emitters 130 are selectively activated or deactivated based on the input mode. In some examples, one or more emitters for generating an electric field are activated and one or more emitters for generating an ultrasonic signal are deactivated when multimode stylus 100 is used in the active capacitive input mode while the ultrasonic non-touch input mode is disabled. In some examples, one or more emitters 130 for generating ultrasonic signals is activated and one or more emitters 130 for generating an electric field are deactivated when multimode stylus 100 is used in the ultrasonic non-touch input mode while the active capacitive input mode is disabled. In some examples, one or more emitters 130 generating an ultrasonic signal and one or more emitters 130 for generating an RF or infrared signal are activated when multimode stylus is used in the ultrasonic non-touch input mode. In some examples, both of the one or more emitters 130 for generating an electric field and the one or more emitters 130 for generating an ultrasonic signal are activated when multimode stylus 100 is used concurrently with both the active capacitive and the ultrasonic non-touch input modes.

According to some embodiments, control unit 310 and/or firmware 330 may optionally modulate information onto the signals emitted by the one or more emitters 130 so that the information can be communicated to the host computing device. In some examples, the information may optionally include the identifier for multimode stylus 100 and/or the status information associated with multimode stylus 100. In some examples, multimode stylus 100 may optionally include a coder-decoder (CODEC) or similar element (not shown) to support inclusion of the information onto the signals by applying one or more modulations to the signals.

Control unit 310 is further coupled to status display 140 and mode selection input 150 so that control unit 310 and/or firmware 330 can interact with the user of multimode stylus 100. Using status display 140, control unit 310 and/or firmware 330 can communicate status information for multimode stylus 100 to the user and/or operate a textual and/or graphical interface to solicit a desired input mode for multimode stylus 100. Control unit 310 and/or firmware 330 further use mode selection input 150 to receive input, selections, and/or commands from the user during operation of multimode stylus 100.

Control unit 310 is further coupled to transceiver 170 so that control unit 310 and/or firmware 330 can exchange information with the host computing device. The exchanges of information may optionally include one or more of identifiers for multimode stylus 100 and/or the host computing devices, status information associated with multimode stylus 100 and/or the host computing device, commands received from the host computing device to multimode stylus 100, and/or the like.

Control unit 310 is further coupled to one or more sensors 340 so that control unit 310 and/or firmware 330 can monitor the components and systems of multimode stylus 100. In some examples, the one or more sensors 340 may optionally include one or more tip contact sensors, one or more tip pressure sensors, one or more grip pressure sensors, grip detection sensors, one or more attitude sensors, one or more battery charge sensors, and/or the like. In some examples, the grip pressure and/or grip detection sensors may optionally include a plurality of conductive patches between which resistance due to gripping may be determines, one or more contact switches, one or more pressure switches, and/or the like.

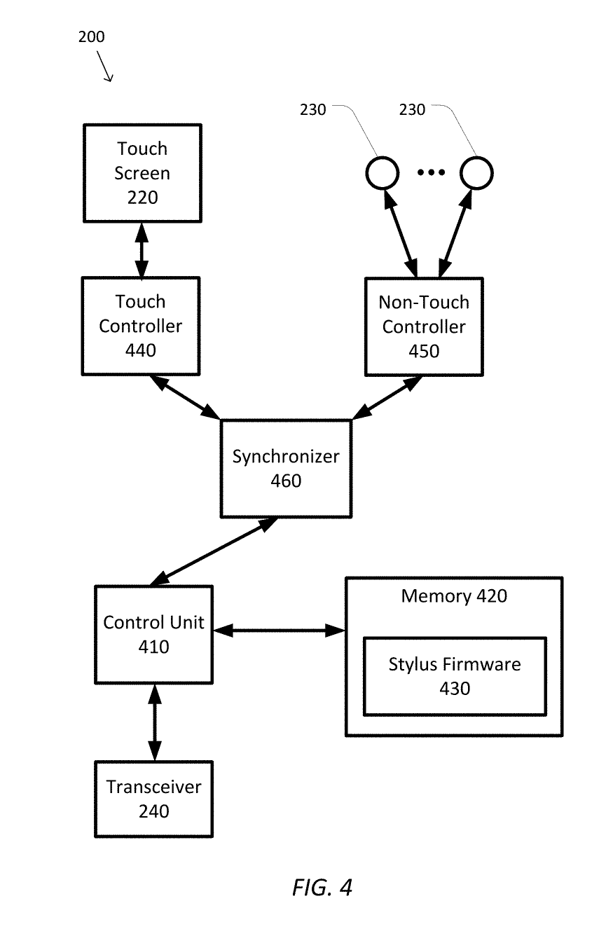

FIG. 4 is a simplified schematic diagram of host computing device 200 according to some embodiments. As shown in FIG. 4, host computing device 200 includes a control unit 410 coupled to memory 420. Operation of host computing device 200 is controlled by control unit 410. Control unit 410 may include one or more central processing units, multi-core processors, microprocessors, microcontrollers, digital signal processors, field programmable gate arrays (FPGAs), application specific integrated circuits (ASICs), and/or the like.

Memory 420 may be used to store software executed by control unit 410 and/or one or more data structures used during operation of host computing device 200. Memory 420 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

As shown, memory 420 includes stylus firmware 430 that may be used to support use of host computing device 200 with a multimode stylus, such as multimode stylus 100. Stylus firmware 430 may include one or more modules for operating the various components in host computing device 200 so that host computing device 200 may be operated to detect a position of the multimode stylus relative to touch screen 220. Additionally, stylus firmware 430 includes one or more modules for selecting a preferred input mode for the multimode stylus and communicating that preference to the multimode stylus as is described in further detail below. In some examples, stylus firmware 430 may include one or more application programming interfaces (APIs) for supporting interoperability among the various components in host computing device 200 and/or the communication of information between host computing device 200 and the multimode stylus. And although stylus firmware 430 is depicted as a software application, stylus firmware 430 may be implemented using hardware, software, and/or a combination of hardware and software.

Host computing device 200 further includes a touch controller 440 coupled to touch screen 220 to provide support for one or more touch input modes of host computing device 200. Touch controller 440 includes arrays of circuits for interfacing to the patterns of conductors, and/or electrodes and/or one or more arrays of emitters and/or sensors located around the periphery of touch screen 220. As the multimode stylus is operated in contact with and/or slightly above the surface of touch screen 220, touch controller 440 tracks the location of the multimode stylus for reporting to control unit 410 and/or stylus firmware 430. In some examples, when touch screen 220 includes a grid of electrodes, such as is consistent with a capacitive touch screen technology, touch controller 440 monitors the electrodes to determine where the multimode stylus has come in contact with touch screen 220. In some examples, when touch screen 220 includes a grid of conductors, such as is consistent with a resistive touch screen technology, touch controller 440 scans through the grid of conductors to determine where the multimode stylus has come in contact with touch screen 220. In some examples, touch controller 440 may optionally include one or more timing devices for observing a time and/or generating a timestamp when each position of the multimode stylus is detected. In some examples, touch controller 440 may optionally include a CODEC or similar element to analyze and/or extract information modulated on the signals by the multimode stylus and detected by touch screen 220 and/or touch controller 440.

In some embodiments, touch controller 440 may also periodically, such as at intervals of several seconds to one or more minutes or longer, measure a power level of touch-based signals detected by touch screen 220 in order to establish a baseline noise level for each supported touch input mode. In some examples, touch controller 440 may optionally aggregate the baseline noise level determined at different times by, for example using an averaging algorithm, an exponential smoothing algorithm, and/or the like. In some examples, touch controller 440 may optionally measure the baseline noise level at times when touch controller 440 concludes that the multimode stylus is not interacting with touch screen 220.

Host computing device 200 further includes a non-touch controller 450 coupled to the plurality of detectors 230 to provide support for one or more non-touch input modes of host computing device 200. Non-touch controller 450 includes a plurality of circuits for detecting signals received by the plurality of detectors 230. In some examples, when host computing device 200 supports an ultrasonic input mode, non-touch controller 450 may monitor signals detected by an RF or infrared detector 240 and two or more ultrasonic detectors 230 to detect differences in arrival times between when a start signal is detected by the RF or infrared detector 240 and ultrasonic signals detected by the two or more ultrasonic detectors 230. Differences between the arrival times are then used to determine a distance between the multimode stylus and the corresponding ultrasonic detector 230. The determined distances are then used to triangulate a location of the multimode stylus relative to host computing device 200. In some examples, non-touch controller 450 may optionally include one or more timing devices for observing a time and/or generating a timestamp when each position of the multimode stylus is detected. In some examples, non-touch controller 450 may optionally include a CODEC or similar element to analyze and/or extract information modulated on the signals by the multimode stylus and detected by the plurality of detectors 230.

In some embodiments, non-touch controller 450 may also periodically, such as at intervals of several seconds to one or more minutes or longer, measure a power level of non-touch-based signals detected by the plurality of detectors 230 in order to establish a baseline noise level for each supported non-touch input mode. In some examples, non-touch controller 450 may optionally aggregate the baseline noise level determined at different times by, for example using an averaging algorithm, an exponential smoothing algorithm, and/or the like. In some examples, non-touch controller 450 may optionally measure the baseline noise level at times when non-touch controller 450 concludes that the multimode stylus is not transmitting signals to the plurality of detectors 230.

According to some embodiments, touch controller 440 and/or non-touch controller 450 may optionally be coupled to control unit 410. In some examples, when host computing device 200 and the multimode stylus support concurrent use of multiple input modes, synchronizer 460 is used to synchronize positional information captured separately by touch controller 440 and non-touch controller 450 because touch controller 440 and non-touch controller 450 may typically provide positional information at different intervals or in different phases relative to each other. In some examples, synchronizer 460 may optionally interpolate positional information from touch controller 440 and/or non-touch controller 450 so that positional data is available to control unit 410 and/or stylus firmware 430 from both touch controller 440 and non-touch controller 450 with the same timestamps. In some examples, the interpolation may be performed using linear, polynomial, and/or other interpolation algorithms. In some examples, synchronizer 460 may optionally include the one or more timing devices used to timestamp the positional data from touch controller 440 and/or non-touch controller 450 in order to synchronize detection times between touch controller 440 and non-touch controller 450. Thus, synchronizer 460 provides support to control unit 410 and/or stylus firmware 430 to aggregate positional information obtained from multiple input modes. In some embodiments, one or more of the functionalities provided by synchronizer 460 may optionally be performed by control unit 410 and/or stylus firmware 430.

Control unit 410 is further coupled to transceiver 240 so that control unit 410 and/or stylus firmware 430 can exchange information with the multimode stylus. The exchanges of information may optionally include one or more of identifiers for host computing device 200 and/or the multimode stylus, status information associated with host computing device 200 and/or the multimode stylus, send commands to the multimode stylus, receive responses and/or acknowledgements to the commands from the multimode stylus, and/or the like.

As discussed above and further emphasized here, FIG. 4 is merely an example which should not unduly limit the scope of the claims. One of ordinary skill in the art would recognize many variations, alternatives, and modifications. According to some embodiments, one or more of the functionalities provided by touch controller 440, non-touch controller 450, and/or synchronizer 460 may alternatively be performed by control unit 410 and/or stylus firmware 430.

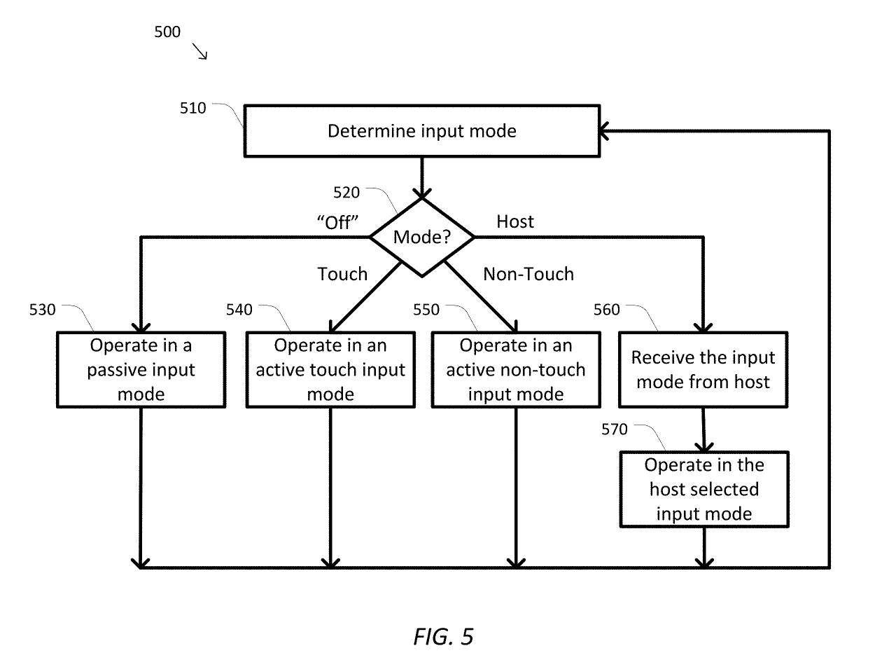

FIG. 5 is a simplified diagram of a method 500 of operating a multimode stylus according to some embodiments. One or more of the processes 510-570 of method 500 may be implemented, at least in part, in the form of executable code (e.g., firmware 330) stored on non-transitory, tangible, machine readable media that when run by one or more processors (e.g., the one or more processors in control unit 310) may cause the one or more processors to perform one or more of the processes 510-570. In some embodiments, method 500 may be performed by a multimode stylus, such as multimode stylus 100, to act as an input device for a host computing device, such as host computing device 200.

At a process 510, an input mode is determined for the multimode stylus. Using some combination of one or more display elements and/or one or more input elements, such as status display 140 and/or mode selection input 150, a user selects a desired input mode for the multimode stylus. In some examples, the user may use the one or more input elements to select the input mode directly, cycle through a list of possible input modes to select the input mode, select the input mode from a menu or other user interface list, and/or the like. In some examples, the selected input mode is then indicated and/or displayed to the user using the one or more display elements. In some examples, the possible input modes may optionally include a passive or “off” input mode, one or more active touch input modes, one or more active non-touch input modes, a host selected input mode, and/or the like.

At a process 520, the determination of process 510 is used to place the multimode stylus in the determined input mode. When the determined input mode is a passive or “off” mode, the multimode stylus is operated in the passive input mode using a process 530. When the determined input mode is an active touch input mode, the multimode stylus is operated in that active touch input mode using a process 540. When the determined input mode is an active non-touch input mode, the multimode stylus is operated in that active non-touch input mode using a process 550. When the determined input mode is a host selected input mode, the multimode stylus is operated in the input mode selected by the host beginning with a process 560.

At the process 530, the multimode stylus is operated in a passive input mode. In the passive or “off” input mode, the multimode stylus is operated in a power conserving mode where the multimode stylus does not actively emit any signals used by a host computing system to detect the position of the multimode stylus. In the examples of multimode stylus 100 from FIGS. 1 and 3, operation in the passive input mode corresponds to each of the one or more emitters 130 being deactivated so that the one or more emitters 130 do not emit any signals. In some examples, the passive input mode corresponds to the multimode stylus being detected by the host computing system using a passive touch technology such as any of resistive, surface acoustic wave, passive capacitive, infrared grid, optical, dispersive signal, acoustic pulse, and/or the like. In some examples, while the multimode stylus is in the passive input mode it is not fully off with the multimode stylus continuing to operate one or more of the one or more display elements, the one or more input elements, a transceiver such as transceiver 170 for communicating with the host computing device, and/or the like. While operating in the passive input mode, the multimode stylus may periodically re-determine the desired input mode for the multimode stylus by returning to process 510.

At the process 540, the multimode stylus is operated in the selected active touch input mode. In contrast to the passive mode of process 530, while in the selected active touch input mode, the multimode stylus activates one or more emitters, such as the one or more emitters 130. The activated one or more emitters then emit one or more signals that typically enhance the ability of the host computing device to accurately detect the position of a tip of the multimode stylus relative to a touch screen, such as touch screen 220. The one or more signals may optionally vary based on a type of active touch screen technology used by the multimode stylus and the touch screen. In some examples, when the active touch screen technology is an active capacitive technology, the one or more signals may correspond to an emitted electric field. In some examples, the active touch input mode may be limited to use when the tip, and thus the one or more emitters, of the multimode stylus are in contact with or hovering just above the touch screen (e.g., within 5-20 mm or so of the surface of the touch screen). In some examples, the one or more signals emitted by the one or more emitters may optionally be modulated to encode information to be communicated to the host computing device. The information may optionally include an identifier for the multimode stylus and/or status information associated with the multimode stylus. While operating in the active touch input mode, the multimode stylus may periodically re-determine the desired input mode for the multimode stylus by returning to process 510.

At the process 550, the multimode stylus is operated in the selected active non-touch input mode. In contrast to the passive input mode of process 530, while in the selected active non-touch input mode, the multimode stylus activates one or more emitters, such as the one or more emitters 130. The activated one or more emitters then emit one or more signals, which are received by a plurality of detectors, such as the plurality of detectors 230, of the host computing device. The one or more signals typically enhance the ability of the host computing device to accurately detect the position of the tip of the multimode stylus relative to the host computing device. The one or more signals may optionally vary based on a type of active non-touch technology used by the multimode stylus and the host computing system. In some examples, when the active non-touch technology is an ultrasonic technology, the one or more signals may correspond to an emitted ultrasonic signal or an emitted ultrasonic signal and an emitted RF or infrared signal as discussed previously. In some examples, the active non-touch input mode has advantages over passive and active touch input modes as the position of the multimode stylus relative to the host computing device is generally still detectable even though the tip of the multimode stylus is not in contact with or hovering slightly above a touch screen, such as when the tip of the multimode stylus is more than a short distance, such as 5-20 mm, above the touch screen and/or located to one of the sides of the touch screen. In some examples, the one or more signals emitted by the one or more emitters may optionally be modulated to encode information to be communicated to the host computing device. The information may optionally include an identifier for the multimode stylus and/or status information associated with the multimode stylus. While operating in the active non-touch input mode, the multimode stylus may periodically re-determine the desired input mode for the multimode stylus by returning to process 510.

At the process 560, the multimode stylus receives an input mode from the host computing device. In the host input mode, multimode stylus defers determination of the input mode in which the multimode stylus is to operate to the host computing device. Deferring the selection of the input mode to the host computing device provides advantages over having the user manually select the input mode and/or override the input mode preferences of the host computing device. In some examples, the host computing device is better able to determine which of the input modes supported by the multimode stylus and the host computing device is able to provide the most accurate and/or appropriate position information on the tip of the multimode stylus. This is because the host computing device is typically better able to evaluate the quality of the reception of the signals emitted by the one or more emitters, such as by determining one or more signal to noise ratios, to determine whether the tip of the multimode stylus is in contact with or hovering just above the touch screen (e.g., within 5-20 mm or so of the surface of the touch screen), and/or the like. In some examples, the multimode stylus may optionally receive the input mode from the host computing device using a transceiver, such as transceiver 170, in the form of one or more packets and/or messages. In some examples, the multimode stylus may optionally acknowledge the input mode received from the host computing device by sending one or more packets and/or messages to the host computing device using the transceiver and/or the one or more emitters. In some examples, the multimode stylus may optionally transmit status information of the multimode stylus to the host computing device using the transceiver and/or the one or more emitters to aid the host computing device in determining the input mode. In some examples, the status information may optionally include a charge level of one or more batteries, such as the one or more batteries 160, of the multimode stylus.

At a process 570, the multimode stylus operates according to the input mode received from the host computing device. During process 570, the multimode stylus may activate or deactivate one or more of the one or emitters in a manner that is consistent with the input mode received from the host computing device during process 560. In some examples, the one or more emitters may optionally be activated and deactivated as described above for the input modes described with respect to processes 530-550. And although not expressly shown in FIG. 5, process 570 may optionally operate in the input mode received from the host computing device by performing the one of the processes 530-550 that is consistent with the input mode received from the host computing device. While operating in the input mode received from the host computing device, the multimode stylus may periodically re-determine the desired input mode for the multimode stylus by returning to process 510.

As discussed above and further emphasized here, FIG. 5 is merely an example which should not unduly limit the scope of the claims. One of ordinary skill in the art would recognize many variations, alternatives, and modifications. According to some embodiments, the multimode stylus may optionally support more than one active touch and/or more than one active non-touch input modes. According to some embodiments, the multimode stylus may optionally operate in multiple input modes concurrently. In some examples, the concurrent modes may optionally include a passive touch input mode and an active non-touch input mode, an active touch input mode and an active non-touch input mode, multiple active touch input modes, multiple active non-touch input modes, and/or the like. In some examples, the multimode stylus may use one input mode to communicate information to the host computing device (e.g., an active non-touch ultrasonic input mode) and another input mode to determine the position of the tip of the multimode stylus (e.g., an active touch input mode).

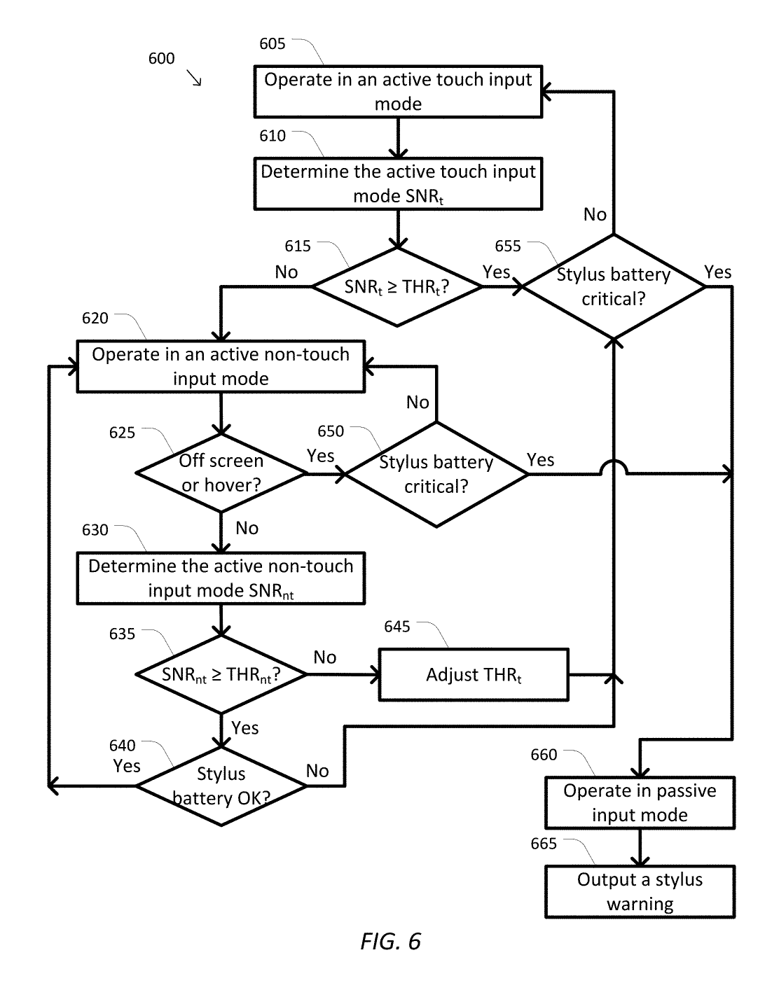

FIG. 6 is a simplified diagram of a method 600 of selecting an input mode for a multimode stylus according to some embodiments. One or more of the processes 605-665 of method 600 may be implemented, at least in part, in the form of executable code (e.g., stylus firmware 430) stored on non-transitory, tangible, machine readable media that when run by one or more processors (e.g., the one or more processors in control unit 410) may cause the one or more processors to perform one or more of the processes 605-665. In some embodiments, method 600 may be performed by a host computing device, such as host computing device 200, to select an input mode determining the position of a multimode stylus, such as multimode stylus 100, relative to the host computing device.

At a process 605, operation in an active touch input mode is begun. In the embodiments of method 600, the host computing device begins in a default starting input mode that is an active touch input mode. As discussed above, the active touch input mode may correspond to any of the input modes where a touch screen, such as touch screen 220, detects one or more signals emitted by one or more emitters of the multimode stylus, such as the one or more emitters 130, when a tip of the multimode stylus is located in contact with or hovers slightly above the surface of the touch screen (e.g., within 5-20 mm or so of the surface of the touch screen). Upon entry into the active touch input mode, the host computing device transmits one or more packets and/or messages to the multimode stylus using a transceiver, such as transceiver 240, to instruct the multimode stylus to begin operating in the active touch input mode. In some examples, the one or more packets and/or messages are received by the multimode stylus during a corresponding process 560. In some examples, the host computing device may optionally wait for confirmation from the multimode stylus that the multimode stylus has switched to the active touch input mode before proceeding. Once in the active touch input mode, the host computing device uses a touch controller, such as touch controller 440, to receive the one or more signals from the multimode stylus and determine a position of the tip of the multimode stylus. In some examples, the active touch input mode may optionally correspond to an active capacitive input mode.

At a process 610, the signal to noise ratio, SNRₜ, of the active touch input mode is determined. As the touch screen of the host computing device is operated in the active touch input mode, a power level of the signals from the multimode stylus that are detected by the touch screen is determined. In some examples, the power level of the signals is determined by the touch controller. The SNRₜ is then determined by determining a ratio of the power level of the signals detected from the multimode stylus with a baseline noise level for the touch screen. In some examples, the baseline noise level is the baseline noise level determined by touch controller 440. In some embodiments, SNRₜ may optionally be further processed to reduce the likelihood of an input mode change due to transient changes in SNRₜ. In some examples, multiple SNRₜ values may be determined over a predetermined and/or configurable interval of time and then aggregated, such as by averaging, exponential smoothing, and/or the like. In some examples, the SNRₜ values may be low pass filtered to remove and/or reduce the effects of transient changes in SNRₜ. In some examples, when the touch screen and/or the touch controller are not able to detect the signals emitted by the multimode stylus that correspond to the active touch mode, the value of SNRₜ is expected to be low, such as approximately 10 decibels or lower.

At a process 615, the SNRₜ is compared to a touch threshold value, THRₜ. In some examples, THRₜ may optionally start at a value in the range of 20 to 60 decibels, such as 25 decibels. In some examples, THRₜ may be configurable, such as through a user interface on the host computing device and/or the multimode stylus. When SNRₜ is at or above THRₜ, the host computing device performs a stylus battery check using a process 655. When SNRₜ is not above THRₜ, the host computing device switches to an active non-touch input mode beginning with a process 620.

At the process 620, operation in the active non-touch input mode is begun. As discussed above, the active non-touch input mode may correspond to any of the input modes where a position of the tip of the multimode stylus is detected without use of a touch screen. In the active non-touch input mode, the host computing devices detects one or more signals emitted by one or more emitters of the multimode stylus, such as the one or more emitters 130, using a plurality of detectors, such as the plurality of detectors 230. Upon entry into the active non-touch input mode, the host computing device transmits one or more packets and/or messages to the multimode stylus using a transceiver, such as transceiver 240, to instruct the multimode stylus to begin operating in the active non-touch input mode. In some examples, the one or more packets and/or messages are received by the multimode stylus during a corresponding process 560. In some examples, the host computing device may optionally wait for confirmation from the multimode stylus that the multimode stylus has switched to the active non-touch input mode before proceeding. Once in the active non-touch input mode, the host computing device uses a non-touch controller, such as non-touch controller 450, to receive the one or more signals from the multimode stylus and determine a position of the tip of the multimode stylus using triangulation and/or some other appropriate method. In some examples, the active non-touch input mode may optionally correspond to an ultrasonic input mode.

At the process 625, the host computing device determines whether the multimode stylus is off screen or hovering and thus likely not detectable by the touch screen. Using the position of the tip of the multimode stylus detected by the host computing device during operation in the active non-touch mode of process 620, a determination is made as to whether the multimode stylus is hovering too far above (e.g., more than 5-20 mm) a surface of the touch screen and/or located to one side of the touch screen and thus considered off screen. When the multimode stylus is hovering too far above the surface of the touch screen or is off screen, the touch screen is not able to determine the position of the tip of the multimode stylus and it would generally be preferable for operation to remain in the active non-touch mode. When the multimode stylus is determined to be hovering too far above the surface of the touch screen or is off screen, a stylus battery check is performed using a process 650. When the multimode stylus is determined to be on screen and not hovering too far above the surface of the touch screen, and is thus detectable by the touch screen, the signal to noise ratio, SNRₙₜ, of the active non-touch input mode is determined using a process 630.

At a process 630, the signal to noise ratio, SNRₙₜ, of the active non-touch input mode is determined. As the plurality of detectors of the host computing device are operated in the active non-touch input mode, a power level of the signals from the multimode stylus that are detected by the plurality of detectors is determined. In some examples, the power level of the signals is determined by the non-touch controller. The SNRₙₜ is then determined by determining a ratio of the power level of the signals detected from the multimode stylus with a baseline noise level for the plurality of detectors. In some embodiments, SNRₙₜ may optionally be further processed to reduce the likelihood of an input mode change due to transient changes in SNRₙₜ. In some examples, multiple SNRₙₜ values may be determined over a predetermined and/or configurable interval of time and then aggregated, such as by averaging, exponential smoothing, and/or the like. In some examples, the SNRₙₜ values may be low pass filtered to remove and/or reduce the effects of transient changes in SNRₙₜ. In some examples, the baseline noise level is the baseline noise level determined by non-touch controller 450. In some examples, when the plurality of detectors and/or the non-touch controller are not able to detect the signals emitted by the multimode stylus that correspond to the active non-touch mode, the value of SNRₙₜ is expected to be low, such as approximately 10 decibels or lower.

At a process 635, the SNRₙₜ is compared to a non-touch threshold value, THRₙₜ. In some examples, THRₙₜ may optionally start at a value in the range of 20 to 60 decibels, such as 30 decibels. In some examples, THRₙₜ may be configurable, such as through a user interface on the host computing device and/or the multimode stylus. In some examples, THRₙₜ may be the SNRₜ value determined during process 610 and/or alternatively an SNRₜ determined periodically while the host computing device is operating in the active non-touch input mode. When SNRₙₜ is at or above THRₙₜ, a stylus battery check is performed using a process 640. When SNRₙₜ is not above THRₙₜ, the host computing device begins the process of switching out of the active non-touch input mode with a process 645.

At the process 640, a charge level of the stylus battery is checked to determine whether one or more batteries of the stylus are above a suitable charge level threshold. Because active non-touch input modes typically operate at a higher power level than active touch input modes the charge level of the one or more stylus batteries are checked before remaining in the active non-touch input mode. In some examples, the charge level of the one or more stylus batteries are communicated to the host computing device using information modulated on the signals emitted by the one or more emitters of the multimode stylus and received by the plurality of detectors and/or information received using the transceiver. In some examples, the charge level of the one or more stylus batteries are checked to see whether it is at an acceptable charge level threshold, such as at least 20-40 percent of a full charge level. In some examples, the acceptable charge level threshold may be configurable, such as through a user interface on the host computing device and/or the multimode stylus. When the charge level of the one or more stylus batteries are is at an acceptable charge level threshold, the input mode remains in the active non-touch input mode by returning to process 620. When the charge level of the one or more stylus batteries are is not at an acceptable charge level threshold, the host computing device begins the process of switching out of the active non-touch input mode with the process 655.

At the process 645, the touch threshold value THRₜ is adjusted. In order to reduce undesirable cycling between the active touch input mode and the active non-touch input mode when SNRₜ is low, the value of THRₜ used during process 615 is adjusted based on SNRₜ. In some examples, THRₜ is set to the value of SNRₜ determined by process 610. In some examples, THRₜ is set to a current value of SNRₜ determined using a process similar to process 610. In some examples, THRₜ is capped at a maximum value, such as the initial value for THRₜ configured by the user. By adjusting the threshold for SNRₜ, excessive cycling between the active touch input mode and the active non-touch input mode is reduced when both SNRₜ and SNRₙₜ are poor. In addition, it is often preferable to remain in the lower power active touch input mode when both SNRₜ and SNRₙₜ are poor. After adjusting THRₜ, a stylus battery check is performed using process 655.

At the process 650, the charge level of the stylus battery is checked to determine whether the one or more stylus batteries are below a critical charge level threshold. Whenever the charge level in the one or more stylus batteries falls below a critical charge level threshold, such as 5-10 percent of the full charge level, it is desirable to switch the multimode stylus to a low power level so that complete loss of power to the multimode stylus does not occur. In some examples, the critical charge level threshold may be configurable, such as through a user interface on the host computing device and/or the multimode stylus. Thus, when the charge level of the one or more stylus batteries remains above the critical charge level threshold, operation continues in the active non-touch input mode by returning to process 620. However, when the charge level of the one or more stylus batteries falls below the critical charge level threshold, the input mode is switched to a passive input mode using a process 660.

At the process 655, the charge level of the stylus battery is checked to determine whether the one or more stylus batteries are below the critical charge level using a process similar to process 650. When the charge level of the one or more stylus batteries remains above the critical charge level threshold, operation continues in the active touch input mode by returning to process 605. However, when the charge level of the one or more stylus batteries falls below the critical charge level threshold, the input mode is switched to the passive input mode using process 660.

At the process 660, operation is switched to the passive input mode. As discussed above, the passive input mode may correspond to any of the passive touch input modes where a touch screen, such as touch screen 220, detects the tip of the multimode stylus without the multimode stylus emitting any signals for detection by the touch screen. Upon entry into the passive input mode, the host computing device transmits one or more packets and/or messages to the multimode stylus using the transceiver to instruct the multimode stylus to begin operating in the passive input mode. In some examples, the one or more packets and/or messages are received by the multimode stylus during a corresponding process 560. In some examples, the host computing device may optionally wait for confirmation from the multimode stylus that the multimode stylus has switched to the passive input mode before proceeding. Once in the passive input mode, the host computing device uses the touch screen and/or the touch controller to detect the position of the tip of the multimode stylus.

At a process 665, a stylus warning is output by the host computing device. Using the display capabilities of the touch screen, one or more status indicators, and/or one or more audio signals, the host computing device alerts the user that the multimode stylus is being switched to the passive input mode. In some examples, the stylus warning may optionally further include a recommendation to recharge the multimode stylus and/or replace one or more batteries in the multimode stylus. In some examples, the stylus warning may optionally further include transmitting one or more status indicators to the multimode stylus for display on the multimode stylus, such as on status display 140.

As discussed above and further emphasized here, FIG. 6 is merely an example which should not unduly limit the scope of the claims. One of ordinary skill in the art would recognize many variations, alternatives, and modifications. According to some embodiments, the initial input mode may optionally default to another of the input modes other than the active touch mode. According to some embodiments, operation automatically switches to the passive input mode when communication with the active stylus is lost. In some examples, loss of communication may optionally be determined when the exchange of heartbeat messages with the multimode stylus using the transceiver fails. According to some embodiments, process 645 is optional and may be omitted with the stylus battery check of process 655 being performed without adjusting THRₜ using process 645.

According to some embodiments, the determination of process 615 may optionally also consider the charge level of the one or more batteries of the stylus before switching to operation in the active non-touch input mode using process 620. In some examples, process 615 further determines whether the charge level of the one or more batteries of the stylus is above the acceptable charge level threshold before switching to operation in the active non-touch input mode. Thus, when either SNRₜ is above the threshold value, the charge level of the one or more batteries of the stylus is below the acceptable charge level threshold, or both, operation continues in the active touch input mode with the additional stylus battery check of process 655. When SNRₜ is below the threshold value and the charge level of the one or more batteries of the stylus is above the acceptable charge level threshold, operation switches to the active non-touch input mode using process 620.

According to some embodiments, THRₙₜ may optionally be adjusted to reduce the likelihood of switching back to the active touch input mode during periods when the active touch input mode is operating poorly. In some examples, when SNRₜ is below a minimum threshold value and before comparing SNRₙₜ to THRₙₜ during process 635, the value of THRₙₜ may be reduced by a nominal value, such as 3 decibels or so. In some examples, the minimum threshold value may be 10 decibels. In some examples, the minimum threshold value may be configurable, such as through a user interface on the host computing device and/or the multimode stylus. In some examples, when SNRₜ is at or above a maximum threshold value and before comparing SNRₙₜ to THRₙₜ during process 635, the value of THRₙₜ may be increased by a nominal value, such as 3 decibels or so, and/or reset to its initial value, such as the THRₙₜ configured by the user. In some examples, the maximum threshold value may be 60 decibels. In some examples, the maximum threshold value may be configurable, such as through a user interface on the host computing device and/or the multimode stylus.

Some examples of multimode styli, such as multimode stylus 100, and/or host computing devices, such as host computing device 200, may include non-transitory, tangible, machine readable media that include executable code that when run by one or more processors (e.g., the one or more processors of control units 310 and/or 410) may cause the one or more processors to perform the processes of methods 500 and/or 600. Some common forms of machine readable media that may include the processes of methods 500 and/or 600 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications.

What is claimed is:

1. A system comprising:
a touch screen;
a plurality of detectors; and
a control unit configured to:
detect a position of a stylus using the touch screen in an active touch input mode wherein the touch screen detects one or more first signals emitted by the stylus;
determine a signal to noise ratio of the active touch input mode;
switch to detection of the position of the stylus using the plurality of detectors in an active non-touch input mode wherein the plurality of detectors detect one or more second signals emitted by the stylus when the signal to noise ratio of the active touch input mode is lower than a first threshold;
determine a signal to noise ratio of the active non-touch input mode; and
switch back to detection of the position of the stylus using the touch screen in the active touch input mode when the signal to noise ratio of the active non-touch input mode is lower than a second threshold.

2. The system of claim 1, wherein the control unit is further configured to transmit to the stylus using a wireless transceiver whether the detection of the position of the stylus is being performed in the active non-touch input mode or in the active touch input mode.

3. The system of claim 2, wherein the control unit is further configured to receive a confirmation from the stylus using the wireless transceiver.

4. The system of claim 1, wherein the active touch input mode is an active capacitive mode and the one or more first signals are one or more electric fields.

5. The system of claim 1, wherein the active non-touch input mode is an ultrasonic non-touch input mode and the one or more second signals are ultrasonic signals.

6. The system of claim 1, wherein the control unit is further configured to receive status information from the stylus, the status information comprising one or more of a pressure applied to a tip of the stylus, a grip pressure on a housing of the stylus, a grip detection on the housing of the stylus, and a charge level of a battery on the stylus.

7. The system of claim 6, wherein the status information is received using one or more of modulations in the one or more first signals detected by the touch screen, modulations in the one or more second signals detected by the plurality of detectors, and third signals received by a wireless transceiver.

8. The system of claim 1, wherein the control unit is further configured to set the first threshold to the signal to noise ratio of the active touch input mode before switching back to detection of the position of the stylus using the touch screen in the active touch input mode.

9. The system of claim 1, wherein the control unit is further configured to continue detection of the position of the stylus using the plurality of detectors in the active non-touch input mode when the control unit determines that the position of the stylus is hovering too far above a surface of the touch screen or is off the touch screen.

10. The system of claim 1, wherein the control unit is further configured to switch to detection of the position of the stylus using the touch screen in the active touch input mode when a charge level of one or more batteries of the stylus is below a first charge level threshold.

11. The system of claim 10, wherein the control unit is further configured to switch to detection of the position of the stylus using the touch screen in a passive input mode when the charge level of the one or more batteries of the stylus is below a second charge level threshold lower than the first charge level threshold.

12. The system of claim 11, wherein the passive input mode is selected from a group consisting of a resistive mode, a passive capacitive mode, a surface acoustic wave mode, an infrared grid mode, an optical mode, a dispersive signal mode, an acoustic pulse mode, and an electromagnetic resonance mode.

13. The system of claim 1, wherein the control unit is further configured to:
determine a first position of the stylus using the touch screen in the active touch input mode;
determine a second position of the stylus using the plurality of detectors in the active non-touch input mode; and
determine the position of the stylus as a combination of the first and second positions.

14. The system of claim 13, wherein the control unit is further configured to synchronize detection times of the first and second positions.

15. The system of claim 1, wherein the second threshold is the signal to noise ratio of the active touch input mode.

16. The system of claim 1, wherein the control unit is further configured to prevent switching to the active non-touch input mode when a charge level of one or more batteries of the stylus is below a first charge level threshold.

17. The system of claim 1, wherein the control unit is further configured to reduce the second threshold when the signal to noise ratio of the active touch input mode is below a minimum threshold value.

18. The system of claim 17, wherein the control unit is further configured to increase the second threshold when the signal to noise ratio of the active touch input mode is at or above a maximum threshold value.

19. A method comprising:
detecting, by a host computing device, a position of a stylus using a touch screen in an active touch input mode;
determining, by the host computing device, a signal to noise ratio of the active touch input mode;
switching, by the host computing device, to detecting the position of the stylus using a plurality of detectors in an active non-touch input mode when the signal to noise ratio of the active touch input mode is lower than a first threshold;
determining, by the host computing device, a signal to noise ratio of the active non-touch input mode; and
switching, by the host computing device, back to detecting the position of the stylus using the touch screen in the active touch input mode when the signal to noise ratio of the active non-touch input mode is lower than a second threshold;
wherein:
detecting the stylus using the touch screen in the active touch input mode comprises detecting, by the touch screen, one or more first signals emitted by the stylus; and
detecting the stylus using the plurality of detectors in the active non-touch input mode comprises detecting, by the plurality of detectors, one or more second signals emitted by the stylus.

20. The method of claim 19, further comprising transmitting, by the host computing device, to the stylus using a wireless transceiver whether the detecting of the position of the stylus is being performed in the active non-touch input mode or in the active touch input mode to the stylus.

21. The method of claim 19, wherein the active touch input mode is an active capacitive mode and the one or more first signals are one or more electric fields.

22. The method of claim 19, wherein the active non-touch input mode is an ultrasonic non-touch input mode and the one or more second signals are ultrasonic signals.

23. The method of claim 19, further comprising setting, by the host computing device, the first threshold to the signal to noise ratio of the active touch input mode before switching back to detecting the position of the stylus using the touch screen in the active touch input mode.

24. The method of claim 19, further comprising:
determining, by the host computing device, whether the position of the stylus is not detectable using the touch screen in the active touch input mode; and
continuing, by the host computing device, detecting the position of the stylus using the plurality of detectors in the active non-touch input mode when the position of the stylus is hovering too far above a surface of the touch screen or is off the touch screen.

25. The method of claim 19, further comprising switching, by the host computing device, to detecting the position of the stylus using the touch screen in the active touch input mode when a charge level of one or more batteries of the stylus is below a first charge level threshold.

26. The method of claim 25, further comprising switching, by the host computing device, to detecting the position of the stylus using the touch screen in a passive input mode when the charge level of the one or more batteries of the stylus is below a second charge level threshold lower than the first charge level threshold.

27. The method of claim 19, wherein the second threshold is the signal to noise ratio of the active touch input mode.

28. The method of claim 19, further comprising preventing, by the host computing device, switching to the active non-touch input mode when a charge level of one or more batteries of the stylus is below a first charge level threshold.

29. The method of claim 19, further comprising reducing, by the host computing device, the second threshold when the signal to noise ratio of the active touch input mode is below a minimum threshold value.

30. The method of claim 29, further comprising increasing, by the host computing device, the second threshold when the signal to noise ratio of the active touch input mode is at or above a maximum threshold value.

31. A non-transitory computer-readable medium comprising a plurality of computer-readable instructions which when executed by one or more processors associated with a host computing device are adapted to cause the one or more processors to perform a method comprising:
detecting a position of a stylus using a touch screen in an active touch input mode;
determining a signal to noise ratio of the active touch input mode;
switching to detecting the position of the stylus using a plurality of detectors in an active non-touch input mode when the signal to noise ratio of the active touch input mode is lower than a first threshold;
determining a signal to noise ratio of the active non-touch input mode; and
switching back to detecting the position of the stylus using the touch screen in the active touch input mode when the signal to noise ratio of the active non-touch input mode is lower than a second threshold;
wherein:
detecting the stylus using the touch screen in the active touch input mode comprises detecting, by the touch screen, one or more first signals emitted by the stylus; and
detecting the stylus using the plurality of detectors in the active non-touch input mode comprises detecting, by the plurality of detectors, one or more second signals emitted by the stylus.

32. The non-transitory computer-readable medium of claim 31, wherein the method further comprises transmitting to the stylus using a wireless transceiver whether the detecting of the position of the stylus is being performed in the active non-touch input mode or in the active touch input mode to the stylus.

33. The non-transitory computer-readable medium of claim 31, wherein the active touch input mode is an active capacitive mode and the one or more first signals are one or more electric fields.

34. The non-transitory computer-readable medium of claim 31, wherein the active non-touch input mode is an ultrasonic non-touch input mode and the one or more second signals are ultrasonic signals.

35. The non-transitory computer-readable medium of claim 31, wherein the method further comprises setting the first threshold to the signal to noise ratio of the active touch input mode before switching back to detecting the position of the stylus using the touch screen in the active touch input mode.

36. The non-transitory computer-readable medium of claim 31, wherein the method further comprises:
determining whether the position of the stylus is not detectable using the touch screen in the active touch input mode; and
continuing detecting the position of the stylus using the plurality of detectors in the active non-touch input mode when the position of the stylus is hovering too far above a surface of the touch screen or is off the touch screen.

37. The non-transitory computer-readable medium of claim 31, wherein the method further comprises switching to detecting the position of the stylus using the touch screen in the active touch input mode when a charge level of one or more batteries of the stylus is below a first charge level threshold.

38. The non-transitory computer-readable medium of claim 37, wherein the method further comprises switching to detecting the position of the stylus using the touch screen in a passive input mode when the charge level of the one or more batteries of the stylus is below a second charge level threshold lower than the first charge level threshold.

39. The non-transitory computer-readable medium of claim 31, wherein the second threshold is the signal to noise ratio of the active touch input mode.

40. The non-transitory computer-readable medium of claim 31, wherein the method further comprises preventing switching to the active non-touch input mode when a charge level of one or more batteries of the stylus is below a first charge level threshold.

41. The non-transitory computer-readable medium of claim 31, wherein the method further comprises reducing the second threshold when the signal to noise ratio of the active touch input mode is below a minimum threshold value.

42. The non-transitory computer-readable medium of claim 41, wherein the method further comprises increasing the second threshold when the signal to noise ratio of the active touch input mode is at or above a maximum threshold value.
